(19) United States
(12) Patent Application Publication
(10) Pub. No.: US 2006/0164235 A1
(43) Pub. Date: Jul. 27, 2006

(54) Cargo container locking system and method

(76) Inventor: Manickam A. Gounder, Olive Branch, MS (US)

Correspondence Address: H Roy Berkenstock;Wyatt Tarrant & Combs, Suite 800, 1715 Aaron Brenner Drive, Memphis, TN, 37120, US

(21) Appl. No.: 10/537,040

(22) PCT Filed: Jun. 23, 2003
(86) PCT No.: PCT/US03/19783

§ 371 Date: Jun. 1, 2005

Related U.S. Application Data
(60) Provisional application No. 60/391,132, filed on Jun. 24, 2002.

(51) Int. Cl. G08B 1/08; B60R 25/00; E05B 65/00; E05B 65/36

(52) U.S. Cl. 340/539.13; 340/5.73; 70/263; 70/77

(57) ABSTRACT

The present invention is a system including a modular hardware platform consisting of Global Positioning System (GPS) receiver, a programmable micro controller unit, a communication module and a software platform, programmable on site to track, monitor and control access to cargo containers, truck trailers and similar transportable devices to curtail theft, pilferage and from intercession by third parties such as terrorists. The system enables access to the interior of a container to a digital key which contains an authorization password to initiate access to the container. The system may be programmed such that access is denied until the container reaches a preprogrammed destination.

### CROSS-REFERENCE TO RELATED APPLICATION

This application claims priority of Provisional patent application No. 60/391,132 filed Jun. 24, 2002, which is incorporated herein by reference.

### STATEMENT REGARDING FEDERALLY SPONSORED RESEARCH OR DEVELOPMENT

Not Applicable

### BACKGROUND OF THE INVENTION

1. Field of the Invention

The invention relates to a system containing a modular hardware platform consisting of a Global Positioning System (GPS) receiver, a programmable micro controller unit, a communication module and a software platform, programmable for different applications for providing information to predetermined and subsequently designated monitoring stations relating to the position and security of cargo contained in a vehicle. There is a necessity to track and monitor vehicles whether they are moveable assets such as cargo containers, truck trailers, railroad cars or aircraft to deter theft, pilferage and compromise of the vehicle as well as protect from acts of terrorists. Currently, such as the cargo containers and trailers are locked on the outside, which locks may be broken into easily during transit. In the United States alone, billions of dollars of valuable goods are stolen or destroyed yearly. The present invention of a “container” locking system (whether a vehicle or portable container) will provide complete control over the vehicle and cargo assets contained therein starting from origination to destination with location accuracy approaching a few feet and secured transportation of goods in an unopened container.

This invention is directed to a system, which would act as an automated means to lock and unlock containers holding valuable assets to control unauthorized access or theft by locking the assets from inside by means which may be opened only from a preprogrammed location or by authorized personnel as by inputting a current authorized location and “opening” instructions. No such systems are available in the market presently.

2. General Background of the Invention

This is invention constitutes a system including modular hardware and customized software in communication with a locking system for a transportable container or vehicle. This invention relates to a system for tracking and locking and unlocking high value assets like cargo containers and trailers and their contents with digital key locks utilizing memory cards. The system secures access to, and thus the goods in the container by means of an internal locking mechanism (thus tamper-proof from outside) which may only be opened with a predetermined signal and, in the preferred embodiment, when the container/trailer is in a predetermined (preset) location.

In arming, the dispatcher prepares and inserts the dispatch details using customized software which generates a file in encrypted format which is used to lock/unlock the system. Then dispatcher downloads this file to a memory card using a memory card reader/writer connected to the computer. Also the same file will be sent to a receiver (destination) through such as e-mail or mobile telecommunications system. A separate ID is created and given to appropriate, specifically authorized persons to lock/unlock (via the memory card) the container during trip progress for inspection purposes. This enables authorized personnel to inspect the vehicle or contained assets anywhere during transit by means of the programmed memory card.

With the communication module in the present system, a cargo or trailer unit may transmit information in real-time with respect to the container position or locking device status. A special feature of this system is the unit information is that directly routed to the programmed monitors. The data broadcasting may be continuous or “on demand” or both. In continuous mode, the data is preferably programmed to transmit at predetermined intervals. In the “on demand” mode, authorized personnel may request the current location of the transiting unit desired. Once the data reaches a participating monitor (computer), the contained software processes the raw data automatically and current location of the asset unit can be identified. The communication module may be any of the following modes, based on the set-up capacity of the system: two way pager/gsm or cellular/satellite communication modules. Each mode has particular advantages and based on the anticipated application requirement, the particular mode and module are selected. The system is so designed so that it may be adapted to conventional components with minimum hardware modification. The only adaptation required relates to the software embedded into the micro controller board to match the selected mode in the selected preferred embodiment. The particular micro controller board is based on Motorola MMC 2107 Mcore 32 bit controller with built in flash memory.

The present invention is directed to a system, whose functionality is not restricted to a particular sector of the commercial transportation industry but which can be used for multiple applications including sea-going vessels, trains, over the road vehicles and aircraft (including those subject to FAA regulations and related broadcast restrictions). Hence the invention is based on a modular hardware system and customized software support, which make the system suitable for different applications with minimal hardware changes. The security advantages may be adapted to a stationery storage system.

### SUMMARY AND OBJECTS OF INVENTION

The main object of invention is to provide an economical system and a method by which vehicles, such as cargo containers, may be tracked and opened only by authorized personnel and/or at predetermined geographic locations.

It is also an object of the invention to provide a container tracking system which may be readily programmed enroute for position reporting access and verification of unit security from a control station with a capability that upon the container reaching a geographic location, the container may be opened by local entry of an alphanumeric password on such as a programmed memory card.

It is also an object of the invention to provide a method of tracking a vehicle to a destination, providing access information and reading the predetermined destination or position information with a remote reader and authorizing access to the vehicle upon a match of identification verification.

### DESCRIPTION OF THE DRAWINGS

FIG. 1 is a pictorial view of the operative elements of the system of the invention.

FIG. 2 is a block diagram of the components making up the system of the invention.

FIG. 3 is a block diagram of the global positioning receiver of the present invention.

FIG. 4 is a flow chart showing the overall sequence of function of the system.

FIG. 5-1 is a flow chart showing the sequence of function during the system function check.

FIG. 5-2 is a flow chart showing the sequence of function during the system function check.

FIG. 6 is a flow chart showing the sequence of function during the ground positioning system data check.

FIG. 7 is a flow chart showing the sequence of function during the relay control function check.

FIG. 8 is a flow chart showing the sequence of function during the transmission of data by the control unit during operation of the system.

FIG. 9 is a flow chart showing the sequence of function during the reception of data by the cargo unit receiver during operation of the system.

### DESCRIPTION OF THE PREFERRED EMBODIMENTS

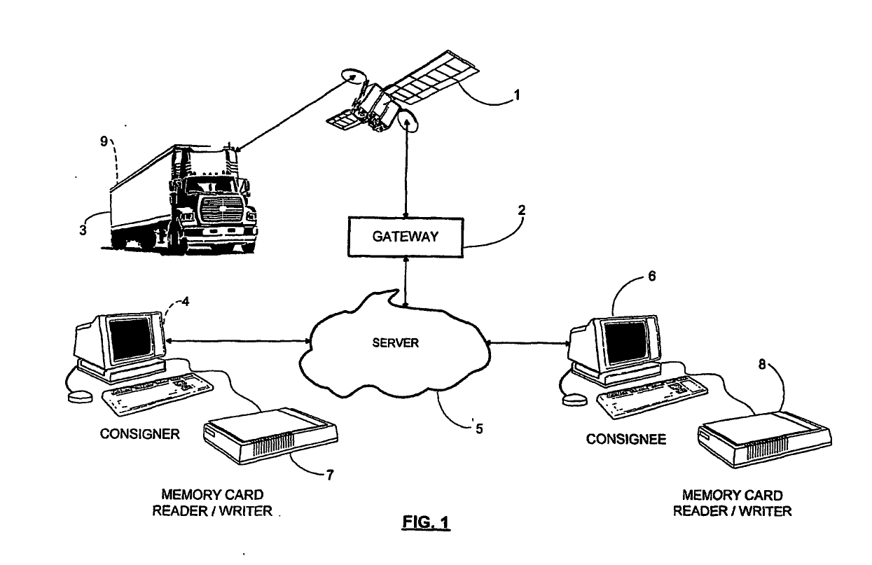

FIG. 1 shows the basic data and information flow diagram of inventive vehicle control and locking system embodied in a cargo container. The dispatcher at a control station (4) such as a freight CONSIGNER will input the dispatch details such as date, time, inventory (summary or detailed), and recipient address with vehicle ID by using given or pre-loaded software in the control station (4). The dispatcher, through the software, generates a trip file in encrypted format. This trip file monitors such as position, time, and velocity, information on the cargo container, and the dispatcher, prior to a trip, inputs such as destination coordinates (longitude and latitude), vehicle ID and passwords of authorized recipients or monitors of the cargo, alarm levels (audio at selected sites and/or at selected monitoring stations). This file is downloaded to a preformatted memory card using memory card reader/writer (7). This memory card (7) functions as a digital key which may be carried by an individual and used to lock/unlock the cargo container (3), which is fitted with a reader device (not shown) which is associated with, and controls, the locking/unlocking mechanism (9) located inside and in proximity to the locking mechanism for the container (3). In operation, the generated file is sent to the recipient station (6) (as a CONSIGNEE of the shipment) to get access into the container (3), through a centralized server (e.g., email server) via such as to the recipient's e-mail address. The recipient station (6) downloads the data file using recipient memory card reader/writer (8) which is then used at the destination location to gain access to the contents of cargo container (3) (The digital access information for recipient memory card (8) is created in the preferred embodiment of the invention such that it will signal cargo container (3) to open only after reaching the input destination (i.e., the preset longitude and latitude). If desired, the software system may include a provision such that an authorized monitor person can gain access through the monitor memory card (7) enabling the examination of cargo container (3) anytime at either a preset or any location during the transit. Access by an individual or by achieving a particular location (as the latitude and longitude of a destination) provide flexibility of operation and are thus selective input parameters to meet the specific needs of a user.

The inventive system also permits the dispatcher and recipient to view current location information by selecting an on-line request command on their respective stations (7), (8). The inventive system will send information to the locking control device (9) mounted in the cargo container (3) through gateway (2) and satellite (1). The locking device control (9) receives the command and validates it and sends back data through satellite (1) and gateway (2) to the requested origin (it may be either dispatcher station (4) or recipient station (6)) and mapping is created by using this data.

The system also affords the possibility of activating locking and unlocking from a remote location through communication module. Activation consists of verifying the authority of the sender of the information (signal) to the server or control station, and then relaying the appropriate authorization and signal to the locking device (9).

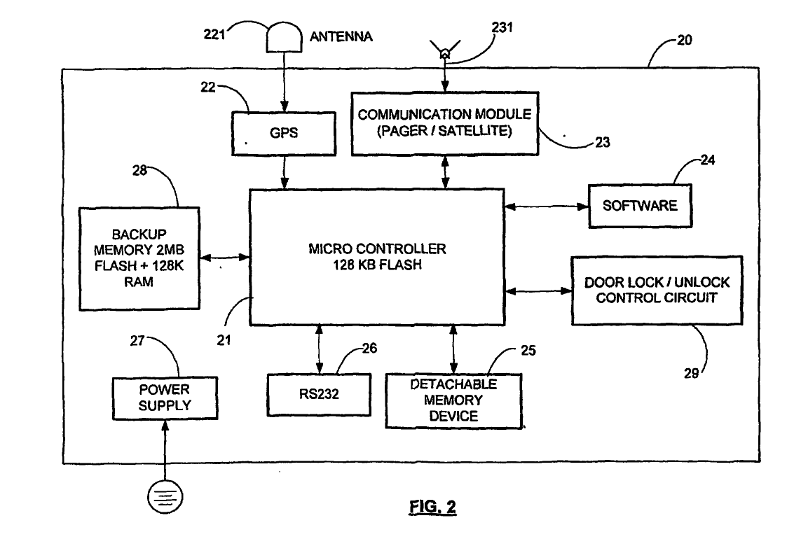

FIG. 2 illustrates a preferred embodiment of the hardware in block diagram form for the core control (20) of the cargo container tracking and locking system. It has a GPS receiver module (22) which may be one of a variety know to those skilled in the art. In the present embodiment, a Motorola M12 ONCORE unit is utilized. The GPS (22) receives the position information signal from a satellite system and gives via a RS-232 output to the micro controller (21) (a Motorola 32 bit embedded controller). Similarly a communication module (it can be either two-way pager module (23) as illustrated, or a satellite module) is used in the system to receive and transmit information to remote stations, as a recipient memory card [FIG. 1] station (8). The communication module receives the information from base station which may be a discrete system service location or may be incorporated in such as the dispatcher control station (6) [FIG. 1], and sends it to microcontroller (21). Likewise the communication module (23) transmits information from the locking control device (9) [FIG. 1] to base station (i.e., door lock/unlock control circuit (29). The communication module (23) and microcontroller (21) are linked through an RS-232 serial interface. This approach provides a real time mode of data transmission.

A data memory card (reader/writer) interface (7) [FIG. 1] is provided in the Mcore controller board (21). A dedicated RISC micro controller is used for this purpose, which communicates with the microcontroller board (21) through high-speed serial interface. The data/information is exchanged between micro controllers and memory card (25) by placing memory card in the cardholder slot, such as reader/writer (7), (8)). Apart from this some external memory and lock actuator circuits are included to complete operation, all as are known in the art. The system also has provision for a RS232 serial port (26) for communicating with a personal computer, as is conveniently used in the dispatcher station (6). The inclusion of serial port (26) enables field programming updating and data download to the PC, such as a portable computer.

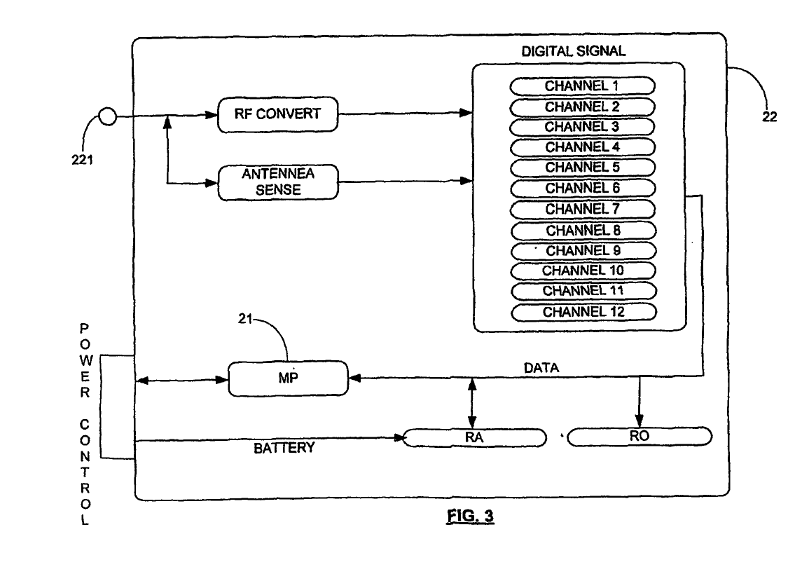

FIG. 3 is a block diagram of an adaptation of a GPS Motorola M12 global positioning system (22) or equivalent which has (in the illustrated embodiment) a 12 channel tracking capability (specifications provided below). The GPS module (22) continues to track through the GPS satellites and calculates time/position information. The calculated information is transferred to the microcontroller (21) through serial interface. The 3V power is also supplied to the module. The GPS module serial connection works at 9600 bps, no parity 8 data bits 1 stop bit connection with m12 binary protocol.

The microcontroller (21) in the system, which is the heart of the system, processes the information received from GPS module and transmit the information either periodically or based on events (as programmed) and also controls the locking/unlocking function through locking device (9). This device when fitted on a vehicle monitors, stores and transmits the following data:
Time
Speed
Latitude of the vehicle
Longitude of the vehicle
Direction of travel of the vehicle
Mileage

The following description gives the specification and the operation parameters of the illustrated embodiment with the following components:

a) Cargo container locking system

b) GPS module

c) Communication module
a. Satellite module
b. Pager module
   System Operational Description:

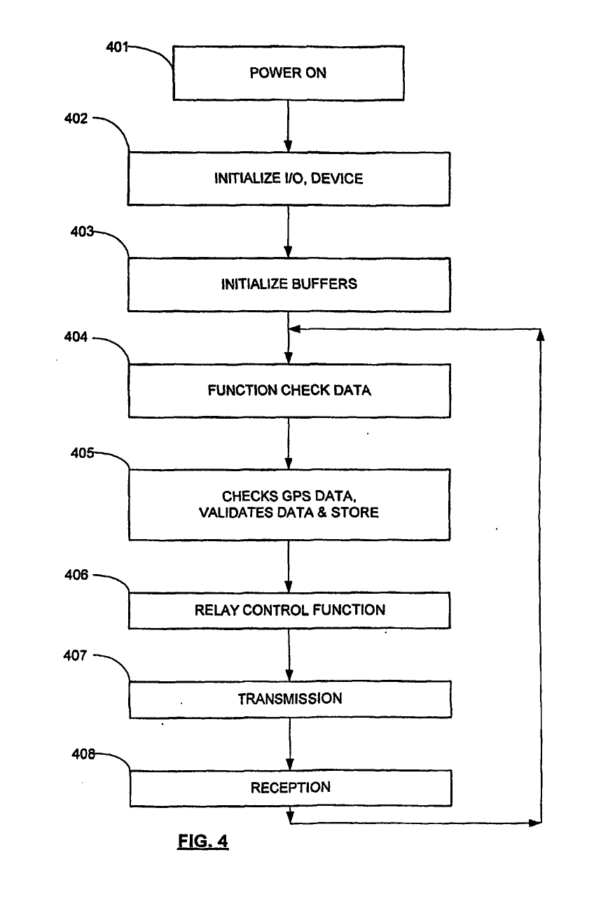

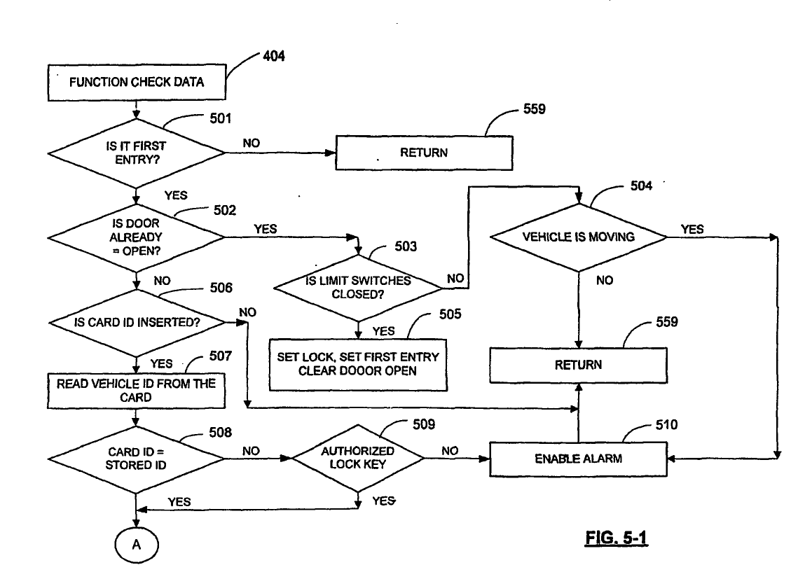

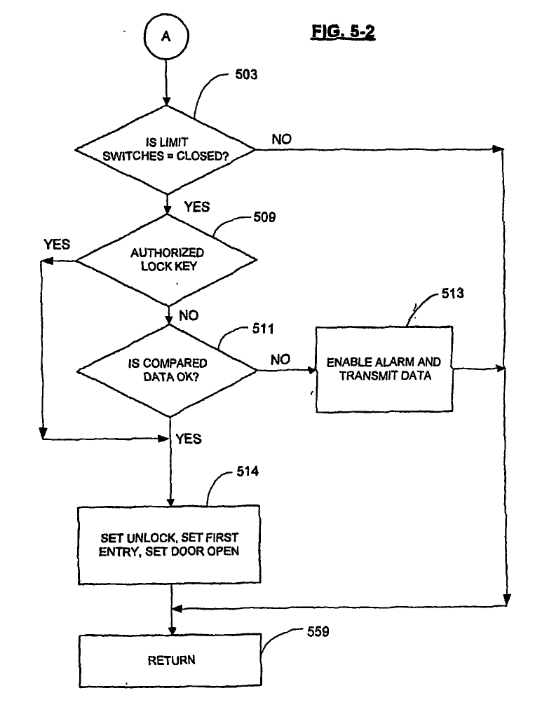

FIGS. 4 through 9 show the methodology of the operational sequence of the illustrated embodiment of the inventive system. The detailed description follows. FIG. 4 shows an overview of the sequence of operation and FIG. 5 through FIG. 9 show the detail of the component functions.

Once the system is powered (401) it will initialize all the I/O lines/device (402) and buffers (403) used in the program and check data (404) including GPS and location data (405), which may initially contain extraneous values during power up. The system then checks relay control function (406), related to the locking and unlocking of the cargo container (3), transmission function (407) for communications, and reception (408) to ensure an accurate transfer of data.

Referring now to FIG. 5-1, the system then performs the data checking (500) operation to carry out appropriate function. The system checks for first entry (501). If this is not a first entry, the indication means the operation is already over for that insertion, alerting the user to make another attempt by removing the memory card and reinserting, and if not, the system simply returns (559) from that function with out any action. This step is to ensure that one insertion of memory card makes only one operation. If the operation is first time, then it checks the previous operation (502). If in previous operation door is opened, then it will check for the limit switch status (503). If the switches are in closed condition, then it will prepare to lock the door by activating relay also sets first entry and clears door open status (505) for the next operation and returns from the function. In case limit switches are not closed or not closed properly and vehicle is on move (504), then an alarm will be enabled, otherwise the system simply returns (559) from the function. This is to make sure to indicate to the operator when the door of container (3) is not properly locked. When the operation is to be performed, it indicates “door open” (previous one is closed), then it looks for card insertion (506). If card is detected then it will read the vehicle ID from the card (507) and compare with (508) embedded vehicle ID in the unit to ensure card validity. If read ID and embedded ID are same then it will check for limit switch status. If the limit switches are in closed condition (503) and there is not an authorized key code (509), then the system will check for destination ID in the form of latitude/longitude coordinates (511) stored in memory card in encrypted format and will be compared with current location coordinates.

Referring now to FIG. 5-2, the current location compared coordinates will be calculated such that in the illustrated embodiment, the system will create a circle of 100 meters with current position coordinates. If the set data (read from card) lies within this Circle of Ambiguity or, get exact matches on both values, then it will prepare to unlock (512) the door and clear the related buffers. Accordingly, the Circle of Ambiguity will preferably be the deciding factor of the accuracy. When the data read from card (25) is not matched with current location, or coordinates are not in the Circle, the system will not allow the actuator 9 to open the doors. In such event, it will enable a alarm signal (513) as well as send a message to the dispatcher station (8) reporting the unauthorized opening attempt.

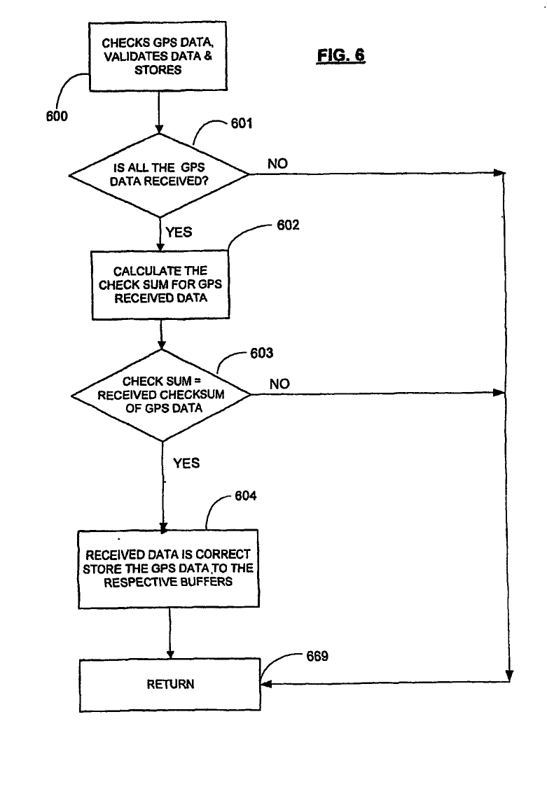

To generate an authorization to open (FIG. 6), a separate coding is initially generated and it will be stored in the memory card (25) and provided to a recipient or other screening individual to enable opening of the container (3). For special in-route monitoring with a non-specific location card, the holder may use the programmed card (25) to unlock the container (3) anywhere in transit. While reading data from the memory card (507), if it is matched with an inputted vehicle ID, it looks for any authorized key data (509). If “yes”, it immediately prepares to unlock (512) the door without checking any conditions and returns (559). In GPS data reception (600), illustrated in FIG. 6, the system receives GPS data through serial communication from GPS receiver (2). It checks for reception completed (601). If “yes”, it calculates the container position (602) for the received data and compares it with data on previously retained for the position (603). If there is a match (603), the data will be stored in respective buffers (604) for further usage.

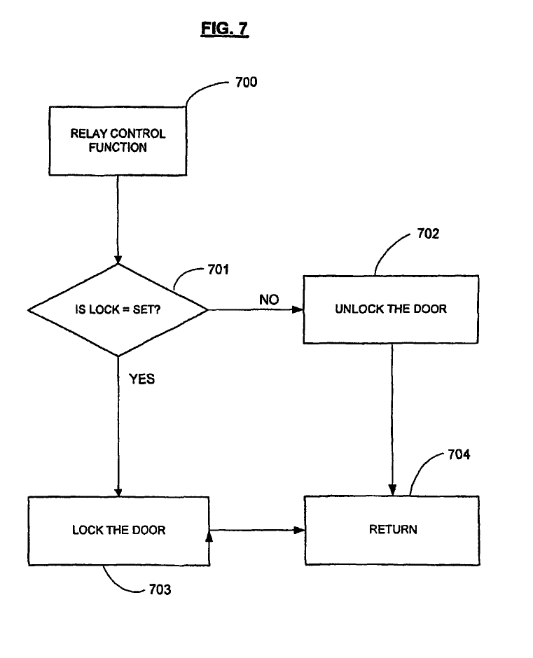

In the relay control function (700), illustrated in FIG. 7, the relay for actuating the locking/unlocking device (9) inside the container (3) [FIG. 1] is based on the operation set in data check 704). The system checks (701) and locks (703) or unlocks (702) appropriately and returns the information to the main control via return (779).

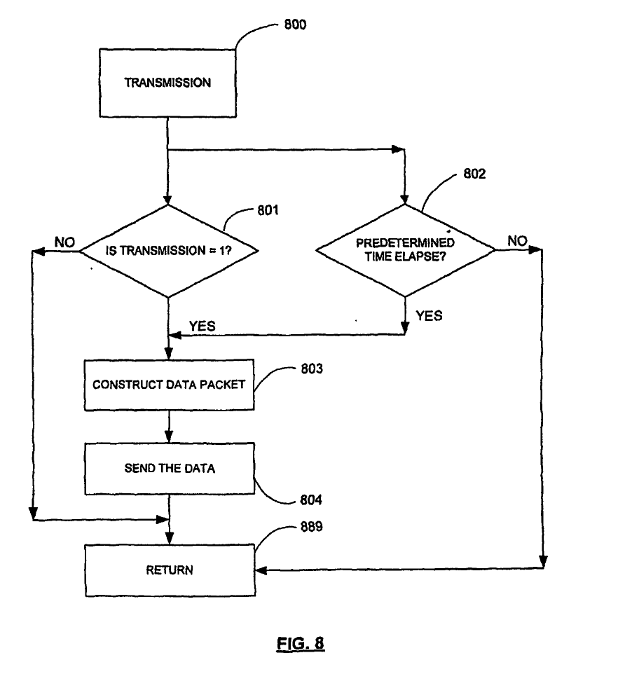

Referring now to FIG. 8, in the message transmission function (800), the system first checks transmission enable condition (801). This will be set during online request or during any unauthorized opening attempt as explained above in the check data function (500). Continuous broadcast also may be made for a predetermined interval. Once the time elapsed or any event (on line request) as from the dispatcher station (6) and/or recipient station (8)) accumulated data is transmitted as a packet (803) which is constructed and sent (804) to the communication module (23) which, as previously explained may be by either satellite module or pager module. The data (803) packet will contain current latitude/longitude, date, time, miles, speed, direction and messages if any.

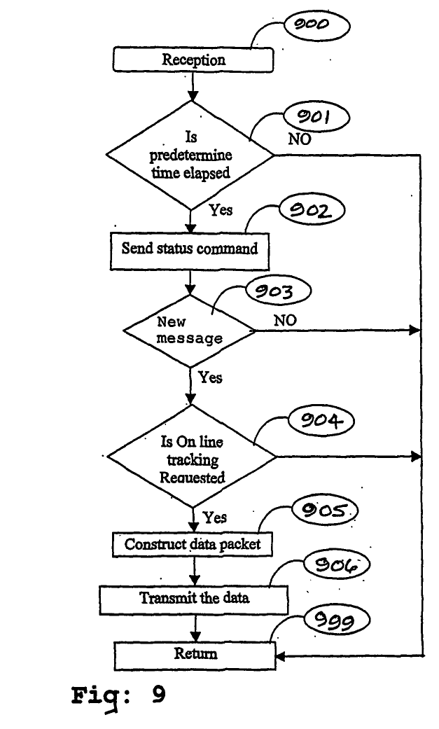

During data reception (900), as is illustrated in FIG. 9, status checks are made, periodically (which in the illustrated embodiment is every 2 minutes (901)). The status packet is sent to the communication module (23), which returns a corresponding packet in—the form of an inbound message (902). If any inbound message is received (803), it is checked for any online request command (904). When the data received is an online command it will enable transmission and functionally returns (999) to continue the above described routine of the container asset tracking system.

Accordingly, the present invention allows the continuous monitoring of an equipped vehicle (such as the illustrated cargo container (or truck trailer). The system is input with data relevant to the container (vehicle), its contents, current location and authorized opening codes and functions. The system uses a centralized data base (computer) to store the input information and control communication between it, the container and authorized intermediate and end users. Access to the system for the intermediate and end users are via a memory data card which contains the level of function (authorization) of the user to access data and/or gain entry to the container (vehicle) itself. The system also monitors the progress (change of location) of the container during the event cycle, and upon input of a preauthorized code, provides data output, and where coded, the user to access the container, intermediate the start location and the programmed end location. In the preferred embodiment, memory read/write cards are utilized to access the system and, depending upon authorization coding, are used to read system data, unlock (input data), and/or reprogram access locations, depending upon whether the specific memory card is so authorized. Those skilled in the art should recognize that the system may be adapted to any vehicular system where controlled access to the vehicle is maintained according to an authorizing device such as a memory card. Access may be preset to be contingent upon the vehicle reaching predetermined locations and certification of identity of the person seeking access, as by the coded memory card. Intermediate functions may also be authorized via coded information on a memory card or on request controlled through the read/write memory card. While the illustrated embodiments feature a GPS system and transfer of information via such as a global computer network, those skilled in the art will recognize that other state of the art communications systems may be utilized to link the data centers, including the centralized location and remote locations, whether computer processing units or memory cards.

For other suggested embodiments, the term “container” may be read as “vehicle” such as an automobile, truck, train, aircraft, ship or boat. The tracking functions may be similar, and the intermediate and final authorizations for access to the container may be replaced or supplemented by security functions, such as enabling further transit, change of operator, and/or access to the particular facilities on the vehicle, such as control functions, power plant (for maintenance and/or repair). Those skilled in the art will recognize the adaptability of the present invention when becoming familiar with the apparatus and function as described herein.

I claim:

1. A computerized system for tracking and controlling a locking device for a transportable container, the system tracking in real time the location of the container using Global Positioning System and a communication module, comprising:
A processing unit disposed in the container, the processing unit receiving real time geographical information from the global positioning system and a communication module to transmit the geographic information;
A central data processing unit including a communications module for receiving and recording geographical information from the communications module of from the container; means for inputting geographical information of a final destination for the transportable container in the central data processing unit including means for comparing the real time geographical information of the container to the final destination geographical information for the container; signaling means connected to the central data processing unit to activate the container locking device to be unlocked when the container reaches its final destination.

2. A system according to claim 1 wherein the locking device contains authorizing means for receiving a predetermined password to initiate the activation of the locking device.

3. A system according to claim 2 wherein the authorizing means is a programmable user insert card and the locking device includes a programmable user card reader.

4. A system according to claim 3 wherein the programmable user card and central data processing unit may be programmed such that the programmable user card will authorize activation of the locking device by overriding the final destination geographic information whereby the container may be opened for inspection intermediate its transportation to a final destination.

5. A system according to claim 1 wherein the locking device includes an alarm means and the alarm is enabled by an unauthorized attempted activation of the locking device.

6. A system according to claim 5 wherein the alarm is an audible alarm.

7. A system according to claim 5 wherein the alarm is communicated to the central data processing unit;

8. A system according to claim 1 wherein the central data processing unit may be accessed by a remote secondary central data processing unit whereby the data retained in the central data processing unit may be monitored and revised from the secondary location.

9. A system having a data processing center for tracking and controlling access to a vehicle, the system tracking in real time the location of the vehicle using a global positioning system and a communication module, comprising:
a processing unit disposed in the vehicle, the processing unit receiving real time geographical information from the global positioning system and a communication module transmitting the geographic information to the data processing center;
the data processing center including a communications module for receiving and recording geographical information from the communications module of from the vehicle; means for inputting geographical information of at least a final destination for the vehicle in the data processing center including means for comparing the real time geographical information of the vehicle to a final destination geographical information for the vehicle; signaling means connected to the data processing center to signal the vehicle processing unit when the vehicle reaches a preprogrammed final destination.

10. A system according to claim 9 wherein the processing unit contains authorizing means for receiving a predetermined password to initiate the activation of the processing unit.

11. A system according to claim 10 wherein the authorizing means is a programmable user insert card and the vehicle includes a programmable user card reader.

12. A system according to claim 11 wherein the programmable user card and data processing center may be programmed such that the programmable user card will authorize activation of the processing unit by overriding the final destination geographic information whereby the vehicle may be accessed intermediate its transportation to a final destination.

13. A system according to claim 9 wherein the processing unit includes an alarm means and the alarm is enabled by an unauthorized attempted activation of the processing unit.

14. A system according to claim 13 wherein the alarm is an audible alarm.

15. A system according to claim 13 wherein the alarm is communicated to the data processing center;

16. A system according to claim 9 wherein the data processing center may be accessed by a remote secondary data processing center whereby the data retained in the data processing center may be monitored and revised from the secondary data processing center.

17. A method for tracking and controlling access to a vehicle, the method including tracking in real time the location of the vehicle using a global positioning system and a communication module, comprising:
receiving real time geographical information in a processing unit on the vehicle from the global positioning system and to transmitting geographic information to the data processing center through communication modules in the processing unit and the data processing center;
receiving and recording geographical information from the communications module of the vehicle; inputting geographical information of at least a final destination for the vehicle in the data processing center including comparing the real time geographical information of the vehicle to a final destination geographical information for the vehicle; signaling the data processing center from the vehicle processing unit when the vehicle reaches a preprogrammed final destination.

18. A method according to claim 17 wherein the method includes receiving a predetermined password by the processing unit to initiate the activation of the processing unit.

19. A system according to claim 18 wherein the method includes using a programmable user insert card and the vehicle includes a programmable user card reader.

20. A method according to claim 19 wherein the programmable user card and data processing center are programmed such that the programmable user card will authorize activation of the processing unit by overriding the final destination geographic information whereby the vehicle may be accessed intermediate its transportation to a final destination.

21. A method according to claim 17 including activation of an alarm in the processing unit enabled by an unauthorized attempted activation of the processing unit.

22. A method according to claim 21 including activating an audible alarm.

23. A method according to claim 21 including communicating the activation of the alarm to the data processing center;

24. A method according to claim 17 including accessing the data processing center d by a remote secondary data processing center and monitoring the data retained in the data processing center and revising the data from the secondary data processing center.
